(19) United States
(12) Patent Application Publication
(10) Pub. No.: US 2025/0308036 A1
(43) Pub. Date: Oct. 2, 2025

(54) SYSTEMS AND METHODS FOR RETRIEVING OBJECTS VIA PROMPT-BASED TRACKING

(71) Applicant: BOARD OF TRUSTEES OF THE UNIVERSITY OF ARKANSAS, Little Rock, AR (US)

(72) Inventors: Khoa Luu, Fayetteville, AR (US); Anh Pha Nguyen, Fayetteville, AR (US)

(73) Assignee: BOARD OF TRUSTEES OF THE UNIVERSITY OF ARKANSAS, Little Rock, AR (US)

(21) Appl. No.: 19/090,248

(22) Filed: Mar. 25, 2025

Related U.S. Application Data
(60) Provisional application No. 63/570,156, filed on Mar. 26, 2024.

(51) Int. Cl. G06T 7/20

(52) U.S. Cl. CPC G06T 7/20; G06T 2207/20081; G06T 2207/20084; G06T 2207/30241

(57) ABSTRACT

Methods for tracking an object are disclosed. The method includes building a third-order tensor. The third-order tensor includes an image from a video, an object trajectory based, at least in part, on a previous image of the video, and text. The method further includes extracting a visual feature from an image region of the image and the object trajectory, determining an attention matrix based, at least in part, on at least one of the image region, the object trajectory, or the text, correlating the image region, the object trajectory, and the text, generating a context-aware object representation, incorporating the context-aware object representation with the visual feature, decoding an object bounding box and score from the context-aware object representation, tracking the object across at least one frame of the video, and predicting a trajectory of the object in the video.

### CROSS-REFERENCE TO RELATED APPLICATIONS

This patent application claims priority from, and incorporates by reference the entire disclosure of, U.S. Provisional Patent Application No. 63/570,156 filed on Mar. 26, 2024.

### STATEMENT REGARDING FEDERALLY SPONSORED RESEARCH

This invention was made with government support under 1946391 awarded by the National Science Foundation. The government has certain rights in the invention.

### TECHNICAL FIELD

The present disclosure relates generally to prompt-based tracking and more particularly, but not by way of limitation, to systems and methods for retrieving objects via prompt-based tracking.

### BACKGROUND

This section provides background information to facilitate a better understanding of the various aspects of the disclosure. The statements in this section of this document are to be read in this light, and not as admissions of prior art.

Multiple Object Tracking (MOT) is a challenging task that requires locating and identifying multiple objects in a video sequence. Existing MOT methods often rely on models trained with predefined object classes to perform tracking. However, these methods are limited by the availability and diversity of object categories and annotations.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method for tracking an object with a textual description. In certain embodiments, the method includes building a third-order tensor. In some embodiments, the third-order tensor includes an image from a video, an object trajectory based, at least in part, on a previous image of the video, and text. In certain embodiments, the method further includes extracting a visual feature from an image region of the image and the object trajectory, determining an attention matrix based, at least in part, on at least one of the image region, the object trajectory, or the text, correlating the image region, the object trajectory, and the text, generating a context-aware object representation, incorporating the context-aware object representation with the visual feature, decoding an object bounding box and score from the context-aware object representation, tracking the object across at least one frame of the video, and predicting a trajectory of the object in the video.

In an addition embodiment, the present disclosure pertains to a system for tracking an object with a textual description. In some embodiments, the system includes memory and at least on processor coupled to the memory. In certain embodiments, the processor configured to implement a method that includes building a third-order tensor. In some embodiments, the third-order tensor includes an image from a video, an object trajectory based, at least in part, on a previous image of the video, and text. In certain embodiments, the method further includes extracting a visual feature from an image region of the image and the object trajectory, determining an attention matrix based, at least in part, on at least one of the image region, the object trajectory, or the text, correlating the image region, the object trajectory, and the text, generating a context-aware object representation, incorporating the context-aware object representation with the visual feature, decoding an object bounding box and score from the context-aware object representation, tracking the object across at least one frame of the video, and predicting a trajectory of the object in the video.

In a further embodiment, the present disclosure pertains to a computer-program product having a non-transitory computer-usable medium having computer-readable program code embodied therein. In certain embodiments, the computer-readable program code is adapted to be executed to implement a method for tracking an object. In certain embodiments, the method includes building a third-order tensor. In some embodiments, the third-order tensor includes an image from a video, an object trajectory based, at least in part, on a previous image of the video, and text. In certain embodiments, the method further includes extracting a visual feature from an image region of the image and the object trajectory, determining an attention matrix based, at least in part, on at least one of the image region, the object trajectory, or the text, correlating the image region, the object trajectory, and the text, generating a context-aware object representation, incorporating the context-aware object representation with the visual feature, decoding an object bounding box and score from the context-aware object representation, tracking the object across at least one frame of the video, and predicting a trajectory of the object in the video.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates an example method for tracking an object with a textual description according to aspects of the present disclosure.

FIGS. 2A-2B illustrate an example of the responsive Type-to-Track. A user provides a video sequence and a prompting request. During tracking, the system is able to discriminate appearance attributes to track the target subjects accordingly and iteratively responds to the user's tracking request.

FIGS. 3A-3B illustrate an example sequence and annotations in a dataset. FIG. 3A illustrates the MOT17 subset sample in both action and appearance. FIG. 3B illustrates the TAO subset samples with captions.

FIGS. 4A-4B illustrate an example word cloud showing words in a language description. FIG. 4A shows the MOT17 subset and FIG. 4B shows the TAO subset.

FIGS. 5A-5B illustrate the auto-regressive manner takes advantage of the equivalent components. Simplifying the correlation in FIG. 5A turns the solution to MENDER in FIG. 5B and reduces complexity to [symbol] (n²) where n denotes the size of tokens. In FIG. 5A, because the tracklet set Tₜ₋₁ pools visual features of the image Iₜ₋₁, the region-prompt is equivalent with tracklet-prompt (only need to filter unassigned objects). FIG. 5B illustrates the structure of the proposed MENDER. It employs a visual backbone to extract visual features and a word embedding to extract textual features. The tracklet-prompt correlation ext(Tₜ₋₁1)×̅emb(P)^{T} is modeled instead of the region-prompt to avoid unnecessary computation caused by no-object tokens.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Language supervision is a technique that leverages natural language descriptions to provide additional guidance and contextual information to computer vision models. By using image-text pairs as inputs, language supervision can help computer vision models learn a richer set of visual concepts and transfer them to various downstream tasks. Tracking objects based on semantic and descriptive text inputs is challenging and requires integrating visual and textual information. Unlike traditional object tracking algorithms that rely on deep visual features representing colors, shapes, and textures, tracking objects based on semantic and descriptive input involves semantic understanding and the matching of the textual description to the objects present in the scene.

Models need to deal with significant challenges, including, but not limited to, class-agnostic object initialization and adapting to scene changes, such as object appearance and disappearance. These challenges affect both the detection and the tracking components of the model. Additionally, the detection component needs to accurately associate the textual description with the corresponding object in each frame. Tracking objects based on semantic and descriptive text inputs also require class-agnostic object initialization, the problem of finding and identifying objects of described types in the text query, without relying on predefined object classes or labels. Various methods have been proposed to approach this problem, including deep learning techniques. However, despite these advances, there is still room for improvement in intuitiveness and responsiveness. One potential way to improve object tracking in videos is to incorporate user input into the tracking process.

Traditional Visual Object Tracking (VOT) methods typically require users to manually select objects in a video by points, bounding boxes, or trained object detectors. Thus, the task that combines responsive typing input to guide the tracking of objects in videos, called Grounded Object Tracking, allows for more intuitive and conversational tracking, as users can simply type in the name or description of the object they wish to track. Most of the recent methods for the Grounded Single Object Tracking task are not class-agnostic, meaning they require prior knowledge of the object. GTI and TransVLT need to input the initial bounding box, while TrackFormer needs the pre-defined category. The operation used to fuse visual and textual features is concatenation which can only support prompts describing a single object.

This disclosure presents, inter alia, a novel framework for Grounded Multiple Object Tracking (GMOT) which is retrieving and tracking objects with text initialization. A new transformer-based eMbed-ENcoDE-extRact framework (MENDER) is introduced with third-order tensor decomposition as the first efficient approach for this task. Advantageously, the proposed MENDER model reduces the computational complexity of third-order correlations by designing an efficient attention method that scales quadratically with reference to the input sizes.

In contrast to the methods above, the MOT approach, MENDER, formulates third-order attention to adaptively focus on many targets, and it is an efficient single-stage and class-agnostic framework. Moreover, even handling three types of input tokens, i.e. text, images, and tracklets, the models presented herein reduce the computational complexity of three-dimension transformer structures, which have cubic time and space complexity, by designing an efficient attention method that scales quadratically with respect to image token size, the numbers of text tokens and tracklets.

### Methods for Tracking an Object

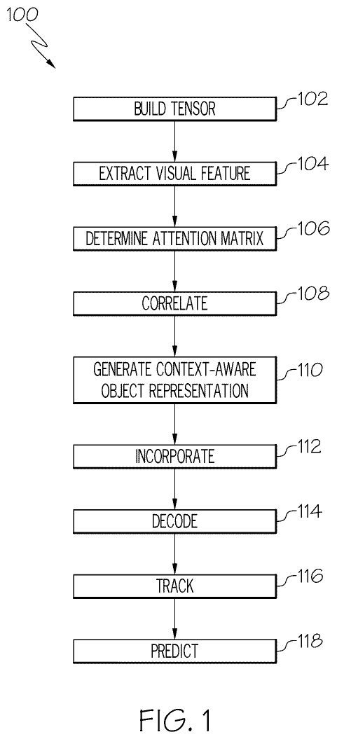

In view of the above, in an embodiment illustrated in FIG. 1, a method for tracking an object with a textual description (100) is disclosed. In some embodiments, the method may include building a tensor (102). In certain embodiments, the tensor may be, for example, a third-order tensor. In some embodiments, the third-order tensor may include an image, an object trajectory, and text. In some embodiments, the image may be from, for example, a video. In some embodiments, the object trajectory is based, at least in part, on a previous image of the video. In certain embodiments, the text may be inputted by a user. In some embodiments, the text is in the form of a prompt which may be provided by, for example, the user.

In some embodiments, the method may also include extracting a visual feature from an image region of the image and the object trajectory (104) and determining an attention matrix (106). In certain embodiments, the attention matrix may be based, at least in part, the image region, the object trajectory, the text, or combinations thereof. In certain embodiments, the attention matrix may include, for example, an image region attention matrix, an object trajectory matrix, a text matrix, or a combination of the same and like. In some embodiments, the attention matrix may be a third-order attention matrix. In certain embodiments, the attention matrix may adaptively focus on a plurality of objects.

In certain embodiments, the method may also include correlating the image region, the object trajectory, and the text (108) and generating a context-aware object representation (110). In some embodiments, the context-aware object representation may be capable of preserving identity information while adapting to changes in position of the object.

In some embodiments, the method may include incorporating the context-aware object representation with the visual feature (112), decoding an object bounding box and score from the context-aware object representation (114), tracking the object across at least one frame of the video (116), and predicting a trajectory of the object in the video (118).

In certain embodiments, the method may include optimizing a parameter associated with the extracting step (104), the encoding step, the decoding step (114), or combinations of the same and like. In some embodiments, optimizing may utilize an algorithm. In certain embodiments, the algorithm may include a deep learning algorithm or similar machine learning technique and/or artificial intelligence algorithms.

In some embodiments, the method may also include encoding the visual feature. In some embodiments, the method may also include scaling. In certain embodiments, the scaling may be performed with a reference. In some embodiments, the reference may be based, at least in part, on an input size. In some embodiments, the scaling may include quadratic scaling. In certain embodiments, the quadratic scaling scales quadratically with respect to input size of the image. In some embodiments, the scaling may include linear scaling or combinations of linear and quadratic scaling.

In certain embodiments, the methods of the present disclosure may be implemented in the form of a system. For example, in certain embodiments, a system may include, for example, memory and at least one processor. In some embodiments, the at least one processor is coupled to the memory. In certain embodiments, the processor is configured to implement the methods as disclosed herein.

Additionally, the methods of the present disclosure may be incorporated into a medium adapted to execute code. For example, in certain embodiments, the medium may include a non-transitory computer-usable medium having computer-readable program code embodied therein. In certain embodiments, the computer-readable program code may be adapted to be executed to implement the methods of the present disclosure.

### Applications and Advantages

The methods of the present disclosure have the potential to impact various fields. For example, the methods of the present disclosure may impact surveillance and robotics, where recognizing object interactions is a crucial task. The methods presented herein can improve the intuitiveness and responsiveness of tracking, making it more practical for video input support in large-language models and real-world applications like popular artificial intelligence systems.

Additionally, the methods presented herein simplify the tensor by making the region-prompt correlation equivalent to the tracklet-prompt correlation. This advantageously reduces complexity from [symbol] (n³) to [symbol] (n²). Moreover, the methods track objects across frames by taking previous tracklets as input to the current frame which allows for adapting to motion.

### EXAMPLE EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Type-to-Track: Retrieve any Object Via Prompt-Based Tracking

One of the recent trends in vision problems is to use natural language captions to describe the objects of interest. This approach can overcome some limitations of traditional methods that rely on bounding boxes or category annotations. This embodiment introduces a novel paradigm for Multiple Object Tracking called Type-to-Track, which allows users to track objects in videos by typing natural language descriptions. Applicant presents a new dataset for that Grounded Multiple Object Tracking task, called GroOT, that contains videos with various types of objects and their corresponding textual captions describing their appearance and action in detail. Additionally, Applicant introduces two new evaluation protocols and formulate evaluation metrics specifically for this task. Applicant develops a new efficient method that models a transformer-based eMbed-ENcoDE-extRact framework (MENDER) using the third-order tensor decomposition. The experiments in five scenarios show that Applicant's

MENDER approach outperforms another two-stage design in terms of accuracy and efficiency, up to 14.7% accuracy and 4× speed faster.

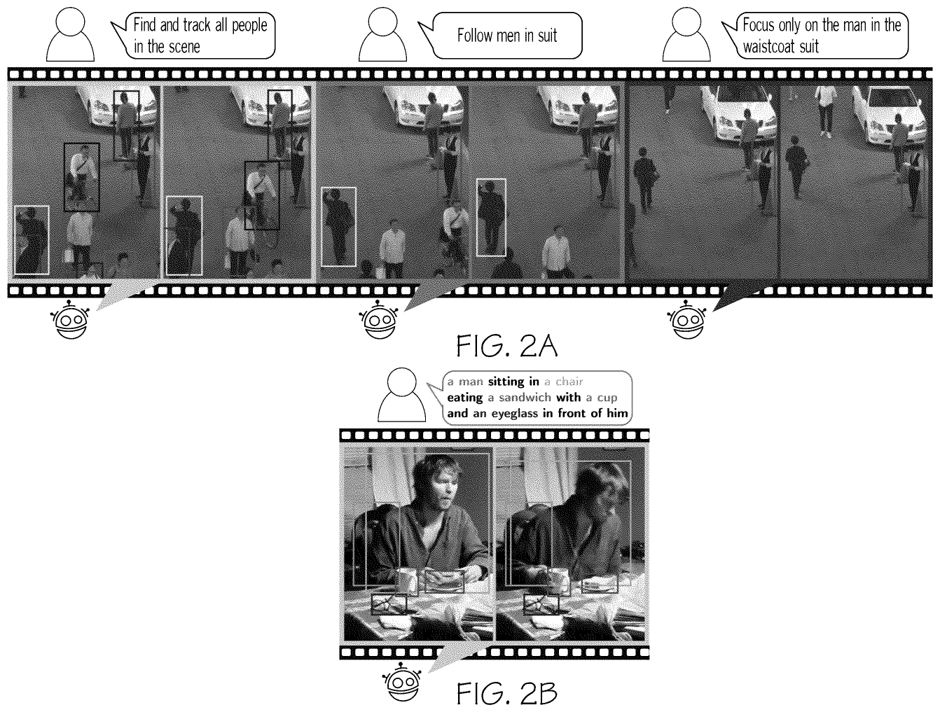

Introduction. Tracking the movement of objects in videos is a challenging task that has received significant attention in recent years. Various methods have been proposed to tackle this problem, including deep learning techniques. However, despite these advances, there is still room for improvement in intuitiveness and responsiveness. One potential way to improve object tracking in videos is to incorporate user input into the tracking process. Traditional Visual Object Tracking (VOT) methods typically require users to manually select objects in the video by points, bounding boxes, or trained object detectors. Thus, in this embodiment, Applicant introduce a new paradigm, called Type-to-Track, to this task that combines responsive typing input to guide the tracking of objects in videos. It allows for more intuitive and conversational tracking, as users can simply type in the name or description of the object they wish to track, as illustrated in FIG. 2A and FIG. 2B. Applicant's intuitive and user-friendly Type-to-Track approach has numerous potential applications, such as surveillance and object retrieval in videos.

Applicant presents a new Grounded Multiple Object Tracking dataset named GroOT that is more advanced than existing tracking datasets. GroOT contains videos with various types of multiple objects and detailed textual descriptions. It is 2× larger and more diverse than any existing datasets, and it can construct many different evaluation settings. In addition to three easy-to-construct experimental settings, Applicant proposes two new settings for prompt-based visual tracking. It brings the total number of settings to five, which will be presented below. These new experimental settings challenge existing designs and highlight the potential for further advancements.

In summary, this embodiment addresses the use of natural language to guide and assist the Multiple Object Tracking (MOT) tasks with the following contributions. First, a novel paradigm named Type-to-Track is proposed, which involves responsive and conversational typing to track any objects in videos. Second, a new GroOT dataset is introduced. It contains videos with various types of objects and their corresponding textual descriptions of 256K words describing definition, appearance, and action. Next, two new evaluation protocols that are tracking by retrieval prompts and caption prompts, and three class-agnostic tracking metrics are formulated for this problem. Finally, a new transformer-based eMbed-ENcoDE-extRact framework (MENDER) is introduced with third-order tensor decomposition as the first efficient approach for this task. Applicant's contributions in this embodiment include a novel paradigm, a rich semantic dataset, an efficient methodology, and challenging benchmarking protocols with new evaluation metrics. These contributions will be advantageous for the field of Grounded MOT by providing a valuable foundation for the development of future algorithms.

Related Work: Visual Object Tracking Datasets and Benchmarks: Datasets. To develop and train VOT models for the computer vision task of tracking objects in videos, various datasets have been created and widely used. Some of the most popular datasets for VOT are OTB, VOT, GOT, MOT challenges and BDD100K. Visual object tracking has two sub-tasks: Single Object Tracking (SOT) and Multiple Object Tracking (MOT). Table 1 shows that there is a wide variety of object tracking datasets in both types available, each with its own strengths and weaknesses. Existing datasets with NLP only support the SOT task, while Applicant's GroOT dataset supports MOT with approximately 2× larger in description size.

Benchmarks. Current benchmarks for tracking can be broadly classified into two main categories: Tracking by Bounding Box and Tracking by Natural Language, depending on the type of initialization. Previous benchmarks were limited to test videos before the emergence of deep trackers. The first publicly available benchmarks for visual tracking were OTB-2013 and OTB-2015, having 50 and 100 video sequences, respectively. GOT-10 k is a benchmark featuring 10K videos classified into 563 classes and 87 motions. TrackingNet, a subset of the object detection benchmark YT-BB, includes 31K sequences. Furthermore, there are long-term tracking benchmarks such as OxUVA and LaSOT. OxUvA spans 14 hours of video in 337 videos, having 366 object tracks. On the other hand, LaSOT is a language-assisted dataset having 1.4K sequences with 9.8K words in their captions. In addition to these benchmarks, TNL2K includes 2K video sequences for natural language-based tracking and focuses on expressing the attributes. LaSOT and TNL2K support one benchmarking setting with their provided prompts, while Applicant's GroOT dataset supports five settings. Ref-KITTI is built upon the KITTI dataset and has two categories, including car and pedestrian, while Applicant's GroOT dataset focuses on category-agnostic tracking, and outnumbers the frames and settings.

A similar task with a different nomenclature to the Grounded MOT task is Referring Video Object Segmentation (Ref-VOS), which primarily measures the overlapping area between the ground truth and prediction for a single foreground object in each caption, with less emphasis on densely tracking multiple objects over time. In contrast, Applicant's proposed Type-to-Track paradigm is distinct in its focus on responsively and conversationally typing to track any objects in videos, requiring maintaining the temporal motions of multiple objects of interest.

Grounded Object Tracking. Grounded Vision-Language Models accurately map language concepts onto visual observations by understanding both vision content and natural language. For instance, visual grounding seeks to identify the location of nouns or short phrases (such as a black hat or a blue bird) within an image. Grounded captioning can generate text descriptions and align predicted words with object regions in an image. Visual dialog enables meaningful dialogues with humans about visual content using natural, conversational language. Some visual dialog systems may incorporate referring expression recognition to resolve expressions in questions or answers.

Grounded Single Object Tracking is limited to tracking a single object with box-initialized and language-assisted methods. The GTI framework decomposes the tracking by language task into three sub-tasks: Grounding, Tracking, and Integration, and generates tubelet predictions frame-by-frame. AdaSwitcher module identifies tracking failure and switches to visual grounding for better tracking. Others introduce a unified system using attention memory and cross-attention modules with learnable semantic prototypes. Another transformer-based approach is presented including a cross-modal fusion module, task-specific heads, and a proxy token-guided fusion module.

Discussion Most existing datasets and benchmarks for object tracking are limited in their coverage and diversity of language and visual concepts. Additionally, the prompts in the existing Grounded SOT benchmarks do not contain variations in covering many objects in a single prompt, which limits the application of existing trackers in practical scenarios. To address this, Applicant presents a new dataset and benchmarking metrics to support the emerging trend of the Grounded MOT, where the goal is to align language descriptions with fine-grained regions or objects in videos.

As shown in Table 2, most of the recent methods for the Grounded SOT task are not class-agnostic, meaning they require prior knowledge of the object. GTI and TransVLT need to input the initial bounding box, while TrackFormer need the pre-defined category. The operation used in a particular GTI to fuse visual and textual features is concatenation which can only support prompts describing a single object. A Grounded MOT can be constructed by integrating a grounded object detector, i.e. MDETR, and an object tracker, i.e. TrackFormer. However, this approach is low-efficient because the visual features have to be extracted multiple times. In contrast, Applicant's proposed MOT approach MENDER formulates third-order attention to adaptively focus on many targets, and it is an efficient single-stage and class-agnostic framework. The scope of class-agnostic in Applicant's approach is constructing a large vocabulary of concepts via a visual-textual corpus.
Table 2. Comparison of key features of tracking methods. Cls-agn is for class-agnostic, while Feat is for the approach of feature fusion and Stages indicates the number of stages in the model design incorporating NLP into the tracking task. NLP indicates how text is utilized for the tracker: assist (w/box) or can initialize (w/o box).

| Approach | Task | NLP | Cls-agn | Feat | Stages |
|---|---|---|---|---|---|
| GTI | SOT | assist | X | concat | single |
| TransVLT | SOT | assist | X | attn | single |
| TrackFormer | MOT | — | X | — | — |
| MDETR + TFm | MOT | init | ✓ | attn | two |
| TransRMOT | MOT | init | ✓ | attn | two |
| MENDER | MOT | init | ✓ | attn | single |

Data Overview: Data Collection and Annotation. Existing object tracking datasets are typically designed for specific types of video scenes. To cover a diverse range of scenes, GroOT was created using official videos and bounding box annotations from the MOT17, TAO, and MOT20. The MOT17 dataset includes 14 sequences with diverse environmental conditions such as crowded scenes, varying viewpoints, and camera motion. The TAO dataset is composed of videos from seven different datasets, such as the ArgoVerse and BDD datasets containing outdoor driving scenes, while LaSOT and YFCC100M datasets include in-the-wild internet videos. Additionally, the AVA, Charades, and HACS datasets include videos depicting human-human and human-object interactions. By combining these datasets, GroOT covers multiple types of scenes and encompasses a wide range of 833 objects. This diversity allows for a wide range of object classes with captions to be included, making it an invaluable resource for training and evaluating visual grounding algorithms.

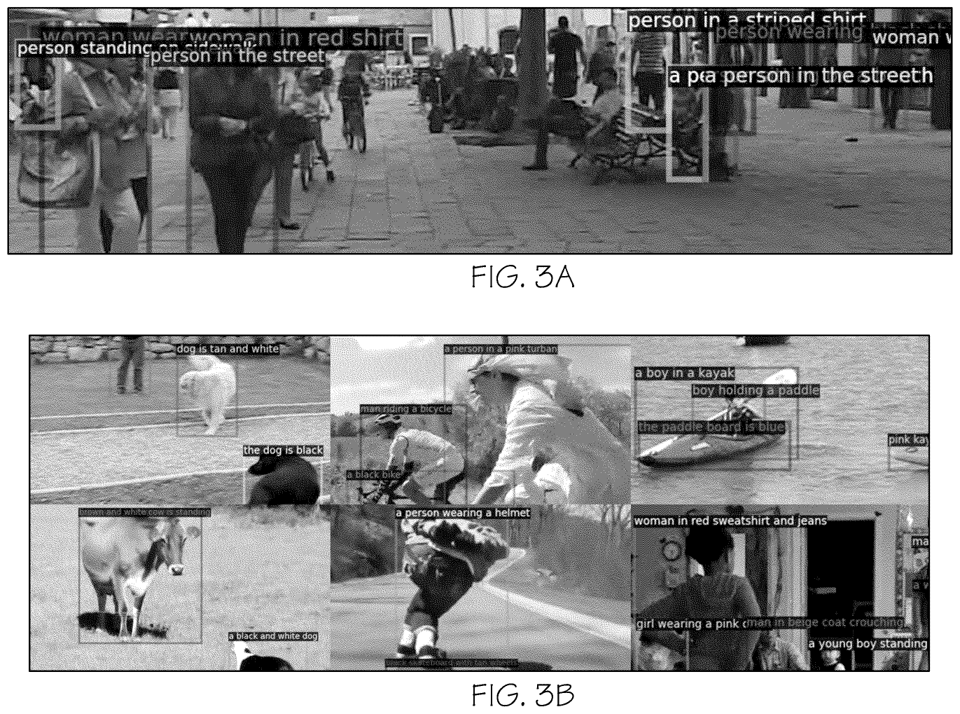

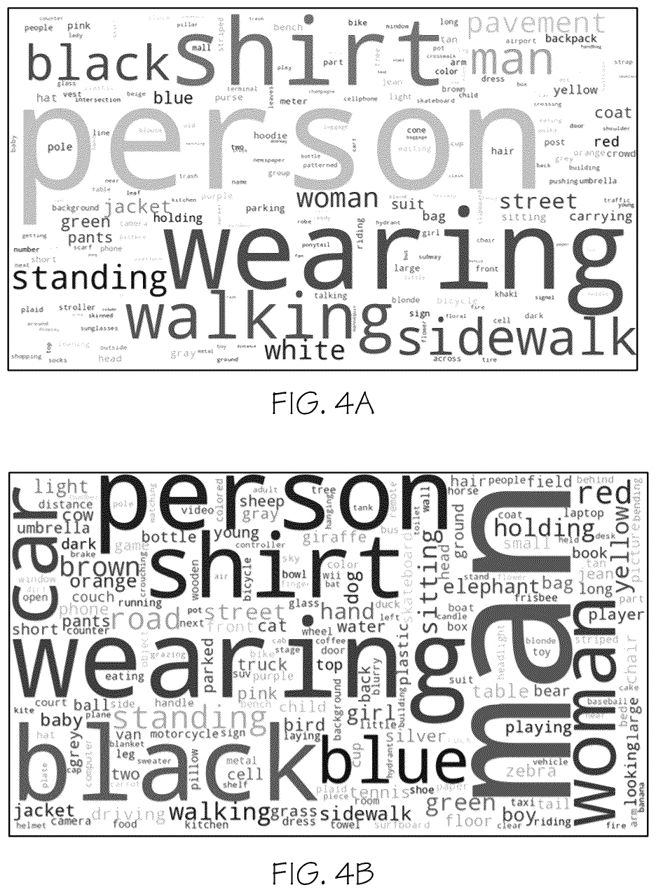

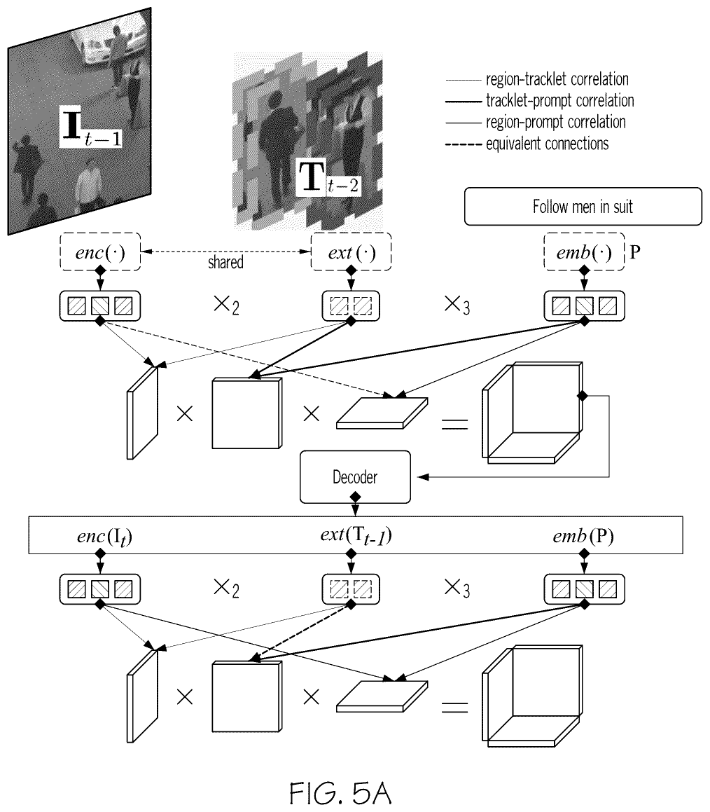

Applicant released the textual description annotations in COCO format. Specifically, a new key ‘captions’ which is a list of strings is attached to each ‘annotations’ item in the official annotation. In the MOT17 subset, Applicant attempts to maintain two types of captions for well-visible objects: one describes the appearance and the other describes the action. For example, the caption for a well-visible person might be [‘a man wearing a gray shirt’, ‘person walking on the street’] as shown in FIG. 3A. However, 10% of tracklets only have one caption type, and 3% do not have any captions due to their low visibility. The physical characteristics of a person or their personal accessories, such as their clothing, bag color, and hair color are considered to be part of their appearance. Therefore, the appearance captions include verbs ‘carrying’ or ‘holding’ to describe personal accessories. In the TAO subset, objects other than humans have one caption describing appearance, for instance, [‘a red and black scooter’]. Objects that are human have the same two types of captions as the MOT17 subset. An example is shown in FIG. 3B. These captions are consistently annotated throughout the tracklets. FIGS. 4A-4B are the word-cloud visualization of Applicant's annotations.

Type-to-Track Benchmarking Protocols. Let V be a video sample lasts t frames, where V={Iₜ|t<|V|} and Iₜ be the image sample at a particular time step t. Applicant defines a request prompt P that describes the objects of interest, and Tᵢ is the set of tracklets of interest up to time step t. The Type-to-Track paradigm requires a tracker network [symbol] (Iₜ, Tₜ₋₁, P) that efficiently take into account Iₜ, Tₜ₋₁, P to produce Tₜ= [symbol] (Iₜ, Tₜ₋₁, P). To advance the task of multiple object retrieval, another benchmarking set is created in addition to the GroOT dataset. While training and testing sets follow a One-to-One scenario, where each caption describes a single tracklet, the new retrieval set contains prompts that follow a One-to-Many scenario, where a short prompt describes multiple objects. This scenario highlights the need for diverse methods to improve the task of multiple object retrieval. The retrieval set is provided with a subset of tracklets in the TAO validation set and three custom retrieval prompts that change throughout the tracking process in a video {Pₜ_{₁}₌₀, Pₜ_{₂}, Pₜ_{₃}}, as depicted in FIG. 2A. The retrieval prompts are generated through a semi-automatic process that involves: (i) selecting the most commonly occurring category in the video, and (ii) cascadingly filtering to the object that appears for the longest duration. In contrast, the caption prompts are created by joining tracklet captions in the scene and keeping it consistent throughout the tracking period. Applicant names these two evaluation scenarios as tracklet captions cap and object retrieval retr. With three more easy-to-construct scenarios, five scenarios in total will be studied for the experiments detailed below. Table 3 presents the statistics of the five settings, and the data portions are highlighted in the corresponding colors.

Class-Agnostic Evaluation Metrics. Long-tailed classification is a very challenging task in imbalanced and large-scale datasets, such as TAO. This is because it is difficult to distinguish between similar fine-grained classes, such as bus and van, due to the class hierarchy. Additionally, it is even more challenging to treat every class independently. The traditional method of evaluating tracking performance leads to inadequate benchmarking and undesired tracking results. In Applicant's Type-to-Track paradigm, the main task is not to classify objects to their correct categories but to retrieve and track the object of interest. Therefore, to alleviate the negative effect, Applicant reformulates the original per-category metrics of MOTA, IDF1, and HOTA into class-agnostic metrics:

$$MOTA = \frac{1}{\vert {CLS}^{n} \vert} {{\sum }_{cls}}^{{CLS}^{n}} {( 1 - \frac{{\sum }_{i} ( {FN}_{t} + {FP}_{t} + {IDS}_{t} )}{{\sum }_{t} {GT}_{t}} )}_{cls} , CA - MOTA = 1 - \frac{{\sum }_{t} {( {FN}_{t} + {FP}_{t} + {IDS}_{t} )}_{{CLS}^{1}}}{{\sum }_{t} {( {GT}_{{CLS}^{1}} )}_{t}} \qquad ( 1 )$$

$$IDF 1 = \frac{1}{\vert {CLS}^{n} \vert} {{\sum }_{cls}}^{{CLS}^{n}} {( \frac{2 \times IDTP}{2 \times IDTP + IDFP + IDFN} )}_{cls} , CA - IDF 1 = \frac{{( 2 \times IDTP )}_{{CLS}^{i}}}{{( 2 \times IDTP + IDFP + IDFN )}_{{CLS}^{1}}} \qquad ( 2 )$$

$$HOTA = \text{} \frac{1}{\vert {CLS}^{n} \vert} {{\sum }_{cls}}^{{CLS}^{n}} {( \sqrt{DetA \cdot AssA} )}_{cls} , CA - HOTA = \sqrt{( {DetA}_{{CLS}^{1}} ) \cdot ( {AssA}_{{CLS}^{1}} )} \qquad ( 3 )$$

where CLSⁿ is the category, set size n is reduced to 1 by combining all elements: CLSⁿ→CLS¹.

Methodology. Problem Formation. Given the image Iₜ and the request prompt P describing the objects of interest, which can adaptively change between {Pₜ_{₁}, Pₜ_{₂}, Pₜ_{₃}} in the retr setting, and K is the prompt's length |P|=K, let enc(⋅) and emb(⋅) be the visual encoder and the word embedding model to extract features of image tokens and prompt tokens, respectively. The resulting outputs, enc(Iₜ)∈ [symbol] ^{M×D} and emb(P)∈ [symbol] ^{K×D}, where D is the length of feature dimensions. A list of region-prompt associations Cₜ, which contains objects' bounding boxes and their confident scores, can be produced by Eqn. (4):

$${C}_{t} = \text{} {dec}_{γ} ( enc ( {I}_{t} ) \overline{\times } {emb ( P )}^{T} , enc ( {I}_{t} ) ) = {\{ {c}_{i} = ( {c}_{x} , {c}_{y} , {c}_{ω} , {c}_{h} , {c}_{conf} ) , \vert i < M \}}_{t} \qquad ( 4 )$$

where (x̅) is an operation representing the region-prompt correlation, that will be elaborated below,

$$\begin{matrix}dec \\ γ\end{matrix} ( \cdot , \cdot )$$

is an object decoder taking the similarity and the image features to decode to object locations, thresholded by a scoring parameter γ (i.e. c_{conf}≥γ). For simplicity, the cardinality of the set of objects |Cₜ|=M, implying each image token produces one region-text correlation.

Applicant defines Tₜ={trⱼ=(trₓ, tr_{y}, tr_{w}, trₕ, tr_{conf}, tr_{id},)ⱼ|j<N}ₜ produced by the tracker [symbol] , where N=|Tₜ| is the cardinality of current tracklets. i, j, k, and t are consistently denoted as indexers for objects, tracklets, prompt tokens, and time steps throughout.

Remark 1 Third-order Tensor Modeling. Since the Type-to-Track paradigm requires three input components Iₜ, Tₜ₋₁, and P, an auto-regressive single-stage end-to-end framework can be formulated via third-order tensor modeling.

To achieve this objective, a combination of initialization, object decoding, visual encoding, feature extraction, word embedding, and aggregation can be formulated as in Eqn. (5):

$${T}_{t} = \{ \begin{matrix}initialize ( {C}_{t} ) & t = 0 \\ {dec}_{γ} ( {1}_{D \times D \times D} {\times }_{1} enc ( {I}_{t} ) {\times }_{2} ext ( {T}_{t - 1 )} {\times }_{3} emb ( P ) , enc ( {I}_{t} ) ) & ∀ t > 0\end{matrix} \qquad ( 5 )$$

where ext(⋅) denotes the visual feature extractor of the set of tracklets, ext(Tₜ₋₁)∈ [symbol] ^{N×D}, 1_{D×D×D} is an all-ones tensor has size D×D×D, (×ₙ) is the n-mode product of the third-order tensor to aggregate many types of token, and initialize(⋅) is the function to ascendingly assign unique identities to tracklets for the first time those tracklets appear.

Let T∈ [symbol] ^{M×N×K} be the resulting tensor T=1_{D×D×D}×₁ enc(Iₜ)×₂ ext(Tₜ₋₁)×₃ emb(P). The objective function can be expressed as the log softmax of the positive region-tracklet-prompt triplet over all possible triplets, defined in Eqn. (6):

$${θ}_{enc , ext , emb}^{*} = arg {max}_{{θ}_{enc , ext , emb}} ( l og ( \frac{exp ( {T}_{ijk} )}{{\sum }_{l}^{K} {\sum }_{n}^{N} {\sum }_{m}^{M} exp ( {T}_{lnm} )} ) ) \qquad ( 6 )$$

where θ denotes the network's parameters, the combination of the i^{th} image token, the j^{th} tracklet, and the k^{th} prompt token is the correlated triplet.

In the following, Applicant elaborates the model design for the tracking function T(Iₜ, Tₜ₋₁, P), named MENDER, as defined in Eqn. (5), and loss functions for the problem objective in Eqn. (6).

MENDER for Multiple Object Tracking by Prompts. The correlation in Eqn. (5) has the cubic time and space complexity [symbol] (n³), which can be intractable as the input length grows and hinder the model scalability.

Remark 2 Correlation Simplification. Since both enc(⋅) and ext(⋅) are visual encoders, the region-prompt correlation can be equivalent to the tracklet-prompt correlation. Therefore, the region-tracklet-prompt correlation tensor T can be simplified to lower the computation footprint.

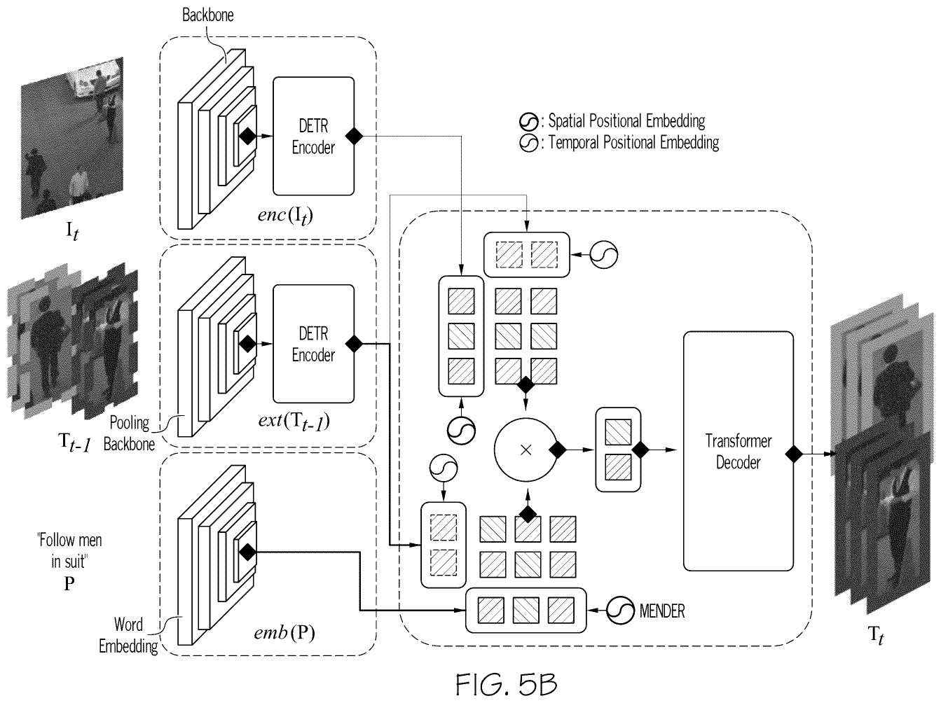

To design that goal, the extractor and encoder share network weights for computational efficiency:

$${ext ( {T}_{t - 1} )}_{j} = ext ( {\{ {tr}_{j} \}}_{t - 1} ) = \{ {enc ( {I}_{t - 1 )} )}_{i} : {c}_{i} ↦ {tr}_{j} \} , therefore ( {( {T}_{: j :} )}_{t - 1} = {( {T}_{i \text{::}} )}_{t} ) : {c}_{i} ↦ {tr}_{j} \qquad ( 7 )$$

where T_{:j:} and T_{i::} are lateral and horizontal slices. In layman's terms, the region-prompt correlation at the time step t−1 is equivalent to the tracklet-prompt correlation at the time step t, as visualized in FIG. 5A and FIG. 5B. Therefore, one practically needs to model the region-tracklet and tracklet-prompt correlations which reduces time and space complexity from [symbol] (n³) to [symbol] (n²), significantly lowering computation footprint. Applicant alternatively rewrites the decoding step in Eqn. (5) as follows:

$${T}_{t} = \text{} {dec}_{γ} \text{} ( ( enc ( {I}_{t} ) \overline{\times } {ext ( {T}_{t - 1} )}^{⊤} ) \times ( ext ( {T}_{t - 1} ) \overline{\times } {emb ( P )}^{⊤} ) \cdot enc ( {I}_{t} ) ) ∀ t > 0 \qquad ( 8 )$$

Correlation Representations. In Applicant's approach, the correlation operation (x̅) is modelled by the multi-head cross-attention mechanism, as depicted in FIG. 4B. The attention matrix can be computed as:

$$σ ( X ) \overline{\times } σ ( Y ) = {𝒜}_{X \vert Y} = softmax ( \frac{( σ ( X ) \times {W}_{Q}^{X} ) \times {( σ ( Y ) \times {W}_{K}^{Y} )}^{T}}{\sqrt{D}} ) \qquad ( 9 )$$

where X and Y tokens are one of these types: region, tracklet, or prompt. σ(⋅) is one of the operations enc(⋅), emb(⋅), or ext(⋅) as the corresponding operation to X or Y. Superscript W_{Q}, W_{K}, and W_{V} are the projection matrices corresponding to X or Y as in the attention mechanism.

Then, the attention weight from the image Iₜ to the prompt P are computed by the matrix multiplication for [symbol] _{I|T} and [symbol] _{T|P} to aggregate the information from two matrices as in Eqn. (8). The result is the matrix [symbol] _{I|T×T|P}= [symbol] _{I|T}× [symbol] _{T|P} that shows the correlation between each input or output. Then, the resulting attention matrix [symbol] _{I|T×T|P} is used to produce the object representations at time t:

$${Z}_{t} = {𝒜}_{I \vert T \times T \vert P} \times ( emb ( P ) \times {W}_{V}^{P} ) + {𝒜}_{I \vert T} \times ( ext ( {T}_{t - 1} ) \times {W}_{V}^{T} ) \qquad ( 10 )$$

Object Decoder dec (⋅) utilizes context-aware features Zₜ that are capable of preserving identity information while adapting to changes in position. The tracklet set Tₜ is defined in the auto-regressive manner to adjust to the movements of the object being tracked as in Eqn. (8). For decoding the final output at any frame, the decoder transforms the object representation by a 3-layer FFN to predict bounding boxes and confidence scores for frame t:

$${T}_{i} = {\{ {tr}_{j} = {( {tr}_{x} , {tr}_{y} , {tr}_{ω} , {tr}_{h} , {tr}_{conf} )}_{j} \}}_{i} {=}^{{tr}_{conf} \geq γ} FFN ( {Z}_{i} + enc ( {I}_{i} ) ) \qquad ( 11 )$$

where the identification information of tracklets, represented by tr_{id}, is not determined directly by the FFN model. Instead, the tr_{id} value is set when the tracklet is first initialized and maintained till its end, similar to tracking-by-attention approaches.

Training Losses. To achieve the training objective function as in Eqn. (6), Applicant formulates the objective function into two loss functions L_{I|T} and L_{T|P} for correlation training and one loss L_{GI}_{ₒ}_{U} for decoder training:

$$ℒ = {γ}_{T \vert P} {L}_{T \vert P} + {γ}_{I \vert T} {L}_{I \vert T} + {γ}_{GIoU} {L}_{GIoU} \qquad ( 12 )$$

where γ_{T|P}, γ_{I|T}, and γ_{GI}_{ₒ}_{U} are corresponding coefficients, which are set to 0.3 by default.

Alignment Loss L_{T|P} is a contrastive loss, which is used to assure the alignment of the ground-truth object feature and caption pairs (T, P) which can be obtained in the dataset. There are two alignment losses used, one for all objects normalized by the number of positive prompt tokens and the other for all prompt tokens normalized by the number of positive objects. The total loss can be expressed as:

$${L}_{T \vert P} = - \frac{1}{\vert {P}^{+} \vert} {{\sum }_{k}}^{\vert {P}^{+} \vert} log ( \frac{exp ( ext {( T )}_{j}^{⊤} \times {emb ( P )}_{k} )}{{{\sum }^{K}}_{i} exp ( {ext ( T )}_{j}^{⊤} \times {emb ( P )}_{t} )} ) - \qquad ( 13 )$$

$$\frac{1}{\vert {T}^{+} \vert} {{\sum }_{j}}^{\vert {T}^{+} \vert} log ( \frac{exp ( emb {( P )}_{k}^{⊤} \times {ext ( T )}_{j} )}{{{\sum }^{N}}_{i} exp ( {emb ( P )}_{k}^{⊤} \times {ext ( T )}_{t} )} )$$

where P⁺ and I⁺ are the sets of positive prompts and image tokens corresponding to the selected enc(I)ᵢ and emb(P)ₖ, respectively.

Objectness Losses. To model the track's temporal changes, Applicant's network learns from training samples that capture both appearance and motion generated by two adjacent frames:

$${L}_{I \vert T} = - {{\sum }_{j}}^{N} log ( \frac{exp ( ext {( T )}_{j}^{⊤} \times {enc ( I )}_{i} )}{{{\sum }^{K}}_{i} exp ( {ext ( T )}_{j}^{⊤} \times {enc ( I )}_{t} )} ) , and {L}_{GIoU} = {{\sum }_{j}}^{N} {ℓ}_{GIoU} ( {tr}_{j} , {obj}_{i} ) \qquad ( 14 )$$

where L_{I|T} is the log-softmax loss to guide the tokens' alignment as similar to Eqn. (13). In the L_{GI}_{ₒ}_{U} loss, objᵢ is the ground truth object corresponding to trⱼ. The optimal assignment between trⱼ or objᵢ to the ground truth object is computed efficiently by the Hungarian algorithm, following DETR. [symbol] _{GI}_{ₒ}_{U} is the Generalized IoU loss.

Experimental Results: Implementation Details: Experimental Scenarios. Applicant creates three types of prompt: category name nm, category synonyms syn, and category definition def. One tracklet captions cap scenario is constructed by Applicant's detailed annotations and one more objects retrieval retr scenario is given in Applicant's custom request prompts. The dataset contains 833 classes, each has a name and a corresponding set of synonyms that are different names for the same category, such as [man, woman, human, pedestrian, boy, girl, child] for person. Additionally, each category is described by a category definition sentence. This definition makes the model deal with the variations in the text prompts. Applicant joins the names, synonyms, definitions, or captions and filter duplicates to construct the prompt. Trained models use as the same type as testing. Applicant annotated the raw tracking data of the best-performant tracker (i.e., BoT-SORT at 80.5% MOTA and 80.2% IDF1) at the time Applicant constructed experiments and used it as the sub-optimal ground truth of MOT17 and MOT20 (parts (2, 4) in Table 3). That is also the raw data used to evaluate all Applicant's ablation studies.

Datasets and Metrics. RefCOCO+ and Flickr30 k serve as pre-trained datasets for acquiring a vocabulary of visual-textual concepts. The ext(⋅) operation is not involved in this training step. After obtaining a pre-trained model from RefCOCO+ and Flickr30 k, Applicant trained and evaluated the model for the proposed Type-to-Track task on all five scenarios on the GroOT dataset and the first-three scenarios for MOT20. The tracking performance is reported in class-agnostic metrics CA-MOTA, CA-IDF1, and CA-HOTA as outlined above, and mAP50 as defined previously defined.

Tokens Production. emb(⋅) utilizes ROBERTa to convert the text input into a sequence of numerical tokens. The tokens are fed into the ROBERTa-base model for text encoding using a 12-layer transformer network with 768 hidden units and 12 self-attention heads per layer. enc(⋅) is implemented using a ResNet-101 as the backbone to extract visual features from the input image. The output of the ResNet is processed by a Deformable DETR encoder to generate visual tokens. For each dimension, Applicant uses sine and cosine functions with different frequencies as positional encodings. A feature resizer combining a list of (Linear, LayerNorm, Dropout) is used to map to size D=512 for all token producers.

Ablation Study: Comparisons in Different Scenarios. Table 4 shows comparisons in the performance of different prompt inputs. For MOT17 and MOT20, the category name is ‘person’, while category definition is ‘a human being’. Since the prompt by category definition is short, it does not differ much from the nm setting. However, the syn setting shuffles between some words, resulting in a slight decrease in CA-MOTA and CA-IDF1. The cap setting results in prompts that contain more diverse and complex vocabulary, and more context-specific information. It is more difficult for the model to accurately localize the objects and identify their identity within the image, as it needs to take into account a wider range of linguistic cues, resulting in a decrease in performance compared to def (59.5% CA-MOTA and 54.8% CA-IDF1 vs 67.3% CA-MOTA and 72.4% CA-IDF1 on MOT17).

For TAO, the def setting has a significant number of variations and many tenuous connections in the scene context, for example, ‘an aircraft that has a fixed wing and is powered by propellers or jets’ for the airplane category. Therefore, it results in a decrease in performance (16.8% CA-MOTA and 27.7% CA-IDF1) compared to cap (20.7% CA-MOTA and 32.0% CA-IDF1), because the cap setting is more specific on the object level than category level. The best performant setting is nm (27.3% CA-MOTA and 37.2% CA-IDF1), where names are combined.

Simplified Attention Representations. Table 4 also presents the effectiveness of different attention representations of the full tensor T (denoted by χ) and the simplified correlation (denoted by ✓). The performance is reported with frame per second (FPS), which is self-measured on one GPU NVIDIA RTX 3060 12 GB. Overall, the performance of simplified correlation is witnessed with a superior speed of up to 2×(7.8 FPS vs 3.4 FPS of cap on MOT17 and 11.5 FPS vs 7.6 FPS of retr on TAO), resulting in and a slight increase in accuracy due to attention stability and precision gain.

Comparisons with a Baseline Design. Due to the new proposed topic, no current work has the same scope or directly solves Applicant's problem. Therefore, Applicant compares the proposed MENDER against a two-stage baseline tracker in Table 5. Applicant uses current SOTA methods to develop this approach, i.e., MDETR for the grounded detector, while TrackFormer for the object tracker. It is worth noting that the MENDER relies on direct regression to locate and track the object of interest, without the need for an explicit grounded object detection stage. Table 5 shows the proposed MENDER outperforms the baseline on both CA-MOTA and CA-IDF1 metrics in all four settings category synonyms, category definition, tracklet captions and object retrieval (25.7% vs. 21.3%, 16.8% vs. 14.6%, 20.7% vs. 15.3% and 32.9% vs. 25.7% CA-MOTA on TAO), while can maintain up to 4× run-time speed (10.3 FPS vs 2.2 FPS). The results indicate that training a single-stage network enhances efficiency and reduces errors by avoiding separate feature extractions for both detection and tracking steps.

Comparisons with State-of-the-Art Approaches. The category name nm setting is also the official MOT benchmark. Table 6 is the comparison of the result on the category name setting on the official leaderboard of MOT17, compared with other state-of-the-art approaches, including ByteTrack and TrackFormer. Note that the proposed MENDER is one of the first attempts at the Grounded MOT task, not to achieve the top rankings on the general MOT leaderboard. In contrast, other SOTA approaches benefit from the efficient single-category design in their separate object detectors, while the single-stage design is agnostic to the category and for flexible textual input. Compared to TrackFormer, the proposed MENDER only demonstrates a marginal decrease in identity assignment (67.1% vs 68.0% CA-IDF1). The decrease in the CA-MOTA stems from the detector's design which integrates flexible input.

Conclusion. Applicant has presented a novel problem of Type-to-Track, which aims to track objects using natural language descriptions instead of bounding boxes or categories, and a large-scale dataset to advance this task. The proposed MENDER model reduces the computational complexity of third-order correlations by designing an efficient attention method that scales quadratically with respect to the input sizes. The experiments on three datasets and five scenarios demonstrate that the model achieves state-of-the-art accuracy and speed for class-agnostic tracking.

The Type-to-Track problem and the proposed MENDER model have the potential to impact various fields, such as surveillance and robotics, where recognizing object interactions is a crucial task. By reformulating the problem with text support, the proposed methodology can improve the intuitiveness and responsiveness of tracking, making it more practical for video input support in large-language models and real-world applications.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method for tracking an object with a textual description, the method comprising:
building a third-order tensor, wherein the third-order tensor comprises:
an image from a video;
an object trajectory based, at least in part, on a previous image of the video; and
text;
extracting a visual feature from an image region of the image and the object trajectory;
determining an attention matrix based, at least in part, on at least one of the image region, the object trajectory, or the text;
correlating the image region, the object trajectory, and the text;
generating a context-aware object representation;
incorporating the context-aware object representation with the visual feature;
decoding an object bounding box and score from the context-aware object representation;
tracking the object across at least one frame of the video; and
predicting a trajectory of the object in the video.

2. The method of claim 1, wherein the attention matrix comprises at least one of an image region attention matrix, an object trajectory matrix, or a text matrix.

3. The method of claim 1, comprising encoding the visual feature.

4. The method of claim 3, comprising optimizing a parameter associated with at least one of the extracting, encoding, or decoding.

5. The method of claim 4, wherein the optimizing comprises a deep learning algorithm.

6. The method of claim 1, comprising scaling with a reference based, at least in part, on an input size.

7. The method of claim 6, wherein the scaling comprises quadratic scaling.

8. A system for tracking an object with a textual description, the system comprising:
memory; and
at least on processor coupled to the memory, the processor configured to implement a method comprising:
building a third-order tensor, wherein the third-order tensor comprises:
an image from a video;
an object trajectory based, at least in part, on a previous image of the video; and text;
extracting a visual feature from an image region of the image and the object trajectory;
determining an attention matrix based, at least in part, on at least one of the image region, the object trajectory, or the text;
correlating the image region, the object trajectory, and the text;
generating a context-aware object representation;
incorporating the context-aware object representation with the visual feature;
decoding an object bounding box and score from the context-aware object representation;
tracking the object across at least one frame of the video; and
predicting a trajectory of the object in the video.

9. The system of claim 8, wherein the attention matrix comprises at least one of an image region attention matrix, an object trajectory matrix, or a text matrix.

10. The system of claim 8, wherein the method comprises encoding the visual feature.

11. The system of claim 10, wherein the method comprises optimizing a parameter associated with at least one of the extracting, encoding, or decoding.

12. The system of claim 11, wherein the optimizing comprises a deep learning algorithm.

13. The system of claim 1, wherein the method comprises scaling with a reference based, at least in part, on an input size.

14. The system of claim 13, wherein the scaling comprises quadratic scaling.

15. A computer-program product comprising a non-transitory computer-usable medium having computer-readable program code embodied therein, the computer-readable program code adapted to be executed to implement a method for tracking an object, the method comprising:
building a third-order tensor, wherein the third-order tensor comprises:
an image from a video;
an object trajectory based, at least in part, on a previous image of the video; and
text;
extracting a visual feature from an image region of the image and the object trajectory;
determining an attention matrix based, at least in part, on at least one of the image region, the object trajectory, or the text;
correlating the image region, the object trajectory, and the text;
generating a context-aware object representation;
incorporating the context-aware object representation with the visual feature;
decoding an object bounding box and score from the context-aware object representation;
tracking the object across at least one frame of the video; and
predicting a trajectory of the object in the video.

16. The computer-program product of claim 15, wherein the attention matrix comprises at least one of an image region attention matrix, an object trajectory matrix, or a text matrix.

17. The computer-program product of claim 15, wherein the method comprises encoding the visual feature.

18. The computer-program product of claim 17, wherein the method comprises optimizing a parameter associated with at least one of the extracting, encoding, or decoding.

19. The computer-program product of claim 18, wherein the optimizing comprises a deep learning algorithm.

20. The computer-program product of claim 15, wherein the method comprises scaling with a reference based, at least in part, on an input size.
